(19) United States
(12) Patent Application Publication
(10) Pub. No.: US 2016/0318440 A1
(43) Pub. Date: Nov. 3, 2016

(54) PRINTED LED EXTERIOR MIRROR INDICATORS

(71) Applicant: FORD GLOBAL TECHNOLOGIES, LLC, Dearborn, MI (US)

(72) Inventors: Stuart C. Salter, White Lake, MI (US); Annette Lynn Huebner, White Lake, MI (US); Cornel Lewis Gardner, Romulus, MI (US); Paul Kenneth Dellock, Northville, MI (US)

(21) Appl. No.: 14/700,740

(22) Filed: Apr. 30, 2015

(51) Int. Cl. B60Q 1/34; B60Q 1/26

(52) U.S. Cl. CPC B60Q 1/34; B60Q 1/2696

(57) ABSTRACT

A warning indicator system for a vehicle includes an indicator for providing visible signals in a portion of a rear vision minor housing. The indicator may be operatively connected to one or both of a proximity sensor system and to a turn signal control system of the vehicle. The indicator provides a visible light signal from a mirror skull cap portion, without using available mirror reflective surface. In embodiments, printed LED strips are associated with the minor skull cap for providing the visible light signal. Rear-vision mirror assemblies including the described warning indicator system are provided.

### TECHNICAL FIELD

This disclosure relates generally to warning signals for motor vehicles. More particularly, the disclosure relates to an improved warning indicator system for a vehicle rear-vision mirror.

### BACKGROUND

It is known to provide mirror-mounted turn signal indicators in vehicles. When mounted in, e.g., a motor vehicle side mirror, turn signal indicators provide a visible warning of an impending turn or lane change to other vehicles, as a supplement to the main turn signal lights typically mounted at least at each of the four corners of the vehicle and associated respectively with the brake light and/or headlight arrays of the vehicle.

As is also known, conventional rear vision mirror arrangements for a vehicle typically create a “blind spot” of varying size, i.e. an area to the side of and behind the vehicle which a driver cannot see by way of rear and/or side view mirrors without significant body movements (turning the head and/or torso, etc.). For this reason, modern motor vehicles are also often equipped with blind spot monitoring systems, typically provided as visual indicators operatively connected to proximity sensor systems. When a vehicle in an adjoining lane is within a driver's blind spot, i.e. is positioned near the driver's vehicle such that the driver may not see the adjoining vehicle in either of the rear or side view mirrors, the adjoining vehicle will still be detected by the proximity sensors, and a visible warning such as a fixed or flashing light is displayed. Viewing the visible warning, the driver is alerted that another vehicle is in an adjoining lane and near her car, and therefore that she should not attempt to change lanes or turn into the path of the adjoining vehicle. Such monitoring systems are also often associated with the vehicle side mirrors for convenient use by a vehicle driver.

Mirror-mounted blind spot indicators and turn signals are typically provided as separate elements (see FIG. 1), most often as separate indicators created by positioning one or more light sources such as light emitting diodes (LEDs) to emit a light of a desired color and pattern through the glass of the mirrored surface. Particularly in smaller side minors, this can occupy a significant portion of the mirrored surface, and indeed when activated has potential to contribute to the size of the vehicle's blind spot by reducing the amount of mirror surface usable by the driver. Also, the electronics associated with conventional LED-based turn signals and blind spot indicators, while relatively simple, occupy significant space and often require a sizable minor housing to accommodate them. Such electronics also increase the cost and complexity of the vehicle manufacturing process, the cost of the vehicle to the consumer, and repair costs in the event minor replacement/repair is required. In turn, conventional indicators such as blind spot indicators may be difficult to see, particularly for drivers with minor visual impairments.

To solve this and other problems, the present disclosure relates to a warning indicator system for installation in a vehicle minor such as a rear vision minor. In embodiments, the warning indicator system provides a turn signal indicator. In other embodiments, the warning indicator system provides a combined turn signal and blind spot indicator. Still other embodiments contemplate use of the described warning indicator system to provide an auxiliary warning to various instrument-panel associated warning lights/icons. Advantageously, the presently described warning indicator system provides a single, large visible light display associated with a rear-vision minor of a vehicle, which is easier to see and more likely to attract the attention of a driver and/or an adjacent motorist than are conventional turn signal/blind spot indicator warning lights.

### SUMMARY

In accordance with the purposes and benefits described herein, in one aspect a warning indicator system is described including a warning indicator disposed to surround a reflective element supported in a rear vision mirror assembly of the vehicle. The warning indicator may be disposed on a portion of a housing of the rear vision mirror assembly.

The warning indicator may be operatively connected to one or both of a turn signal control system and a proximity alert warning system of the vehicle. In other embodiments, a first warning indicator portion is operatively connected to the turn signal control system and a second warning indicator portion is operatively connected to the proximity alert warning system. In embodiments, the warning indicator comprises at least one printed LED strip disposed on a rearwardly facing portion of the housing surrounding the reflective element. In use, a first portion of the warning indicator emits a first visible cue in response to a signal received from the turn signal control system and a second portion of the warning indicator emits a second visible cue that is different from the first visible cue in response to a signal received from the proximity alert warning system.

In another aspect, rear vision mirror assemblies are provided including the warning indicator system described above.

In the following description, there are shown and described embodiments of the disclosed warning indicator system. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed warning indicator, and together with the description serve to explain certain principles thereof. In the drawing:

FIG. 1 depicts a prior art rear-vision minor including a turn signal indicator and a proximity warning indicator signal;

FIG. 2A depicts a printed LED warning indicator according to the present disclosure, operatively connected to a vehicle turn signal control system;

FIG. 2B depicts a printed LED warning indicator according to the present disclosure, operatively connected to a vehicle proximity sensor system; and

FIG. 2C depicts a combined turn signal indicator/blind spot indicator according to the present disclosure.

Reference will now be made in detail to embodiments of the disclosed warning indicator, examples of which are illustrated in the accompanying drawing figures.

### DETAILED DESCRIPTION

The presently disclosed warning indicator system is discussed herein in the context of a rear vision mirror for a vehicle, such as a driver's side exterior mirror. However, it will readily be appreciated that the disclosed warning indicator system is adaptable to other structures such as interior rear view mirrors and others. However, the skilled artisan will readily recognize that the technology is adaptable to passenger's side exterior mirrors, vehicle rear view minors, etc. It will also be appreciated that the described warning indicator may be provided as a supplement to a conventional turn signal indicators and blind spot indicators. Accordingly, the disclosure will not be taken as limiting.

Also, vehicle turn signal control systems and proximity alert warning systems as referenced herein are well-known in the art, and so do not require extensive discussion. However, as is known such turn signal control systems are typically activated by the vehicle driver, for example using controls mounted to a vehicle steering wheel column, to indicate to other motorists that a turn or lane change is imminent. As is also known, proximity alert warning systems providing a blind spot warning to a driver may rely on a variety of sensor types, including camera-based proximity sensor systems, laser-based proximity sensor systems, sonar-based proximity sensor systems, infrared-based proximity sensor systems, ultrasonic wave-based proximity sensor systems, lidar-based proximity sensor systems, radar-based proximity sensor systems, and others.

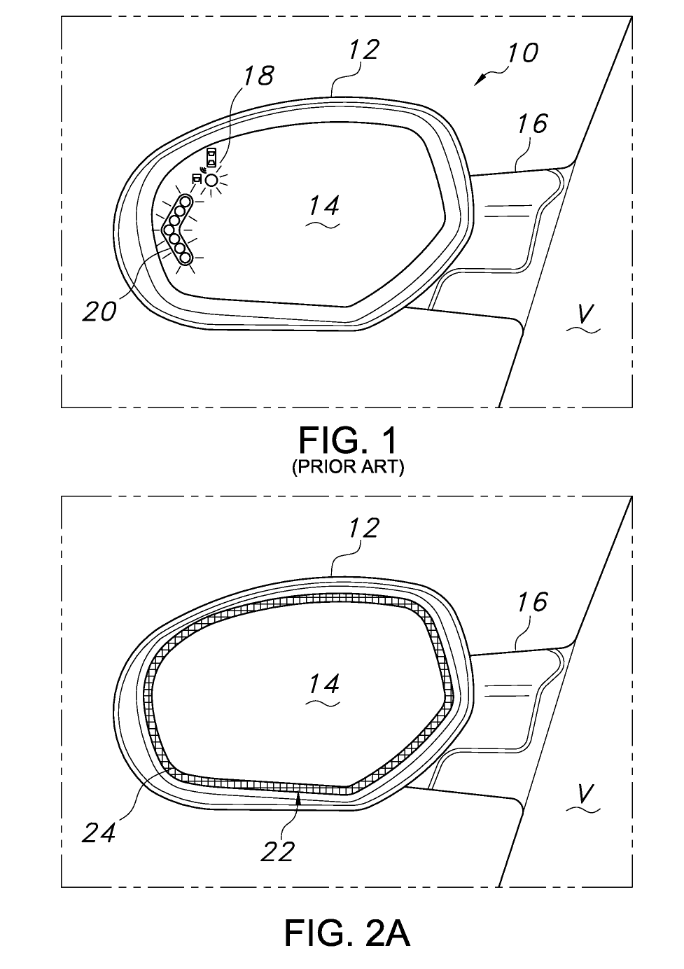

Turning now to FIG. 1, as is known vehicles V typically include exterior rear-vision minors 10 having a housing 12 and a reflective surface 14, mounted to the vehicle V by a stalk 16. As is known, typically stalk 16 is articulated by various mechanisms, to allow at least swinging the housing 12 inwardly towards vehicle V to reduce the likelihood of the rear vision minor 10 striking or being struck by an adjoining vehicle or other obstacle. In turn, various mechanisms may be provided for adjusting an orientation of the reflective surface 14 to adjust the range and/or direction of vision of the rear vision minor 10 in accordance with user height and other preferences. Such adjusting mechanisms for stalk 16 and reflective surface 14 may be manual or automated by a wide variety of mechanisms that are well known in the art and that do not require extensive discussion herein. Still more, a variety of materials and methods for providing a reflective or semi-reflective surface 14 in a rear vision mirror 10 are well known in the art, and likewise do not require extensive discussion.

It is also known in the art to provide proximity alert warning (or “blind spot” monitoring) system indicators 18 and turn signal indicators 20 that are disposed to emit a visible signal through the rear vision minor 10 reflective surface 14. Conventionally, proximity alert warning system indicators 18 and turn signal indicators 20 (often provided by arranging multiple light emitting diodes (LEDs) in a desired shape such as a chevron, see FIG. 1) are provided that emit light signals in specific colors known to catch the attention of drivers, adjacent motorists, etc. (typically red and/or yellow/amber, which are colors generally associated with “danger” and “warning,” respectively).

The turn signal indicator 20 is operatively connected to the vehicle V′s turn signal control system (not shown), and as is known is operated by the user via an actuator typically associated with the vehicle V steering column (not shown), and on actuation emits an intermittent or flashing light signal to alert other motorists that a turn or lane change is imminent. Likewise, the proximity alert system indicator 18 is operatively connected to the vehicle V′s proximity alert system (not shown). On detection of an adjacent vehicle by the proximity alert system, the proximity alert system indicator 18 will emit a light signal (which may be steady or intermittent/flashing, or a combination of the two in accordance with the actual proximity of an adjacent vehicle) to alert the driver that another vehicle is adjacent to her vehicle, and that a lane change or turn should not be attempted.

As summarized above, such mirror-mounted proximity alert warning system indicators 18 and turn signal indicators 20, while effective for their intended purpose, occupy a significant portion of the reflective surface 14, reducing the amount of reflective surface 14 usable by a driver to see adjacent traffic. Also, the electronics associated with conventional LED-based turn signals and proximity alert warning system indicators, while relatively simple, occupy significant space and often require a sizable mirror housing 12 to accommodate them. Such electronics also increase the cost and complexity of the vehicle manufacturing process, the cost of the vehicle to the consumer, and repair costs in the event mirror replacement/repair is required. In turn, conventional indicators such as blind spot indicators may be difficult to see, particularly for drivers with minor visual impairments.

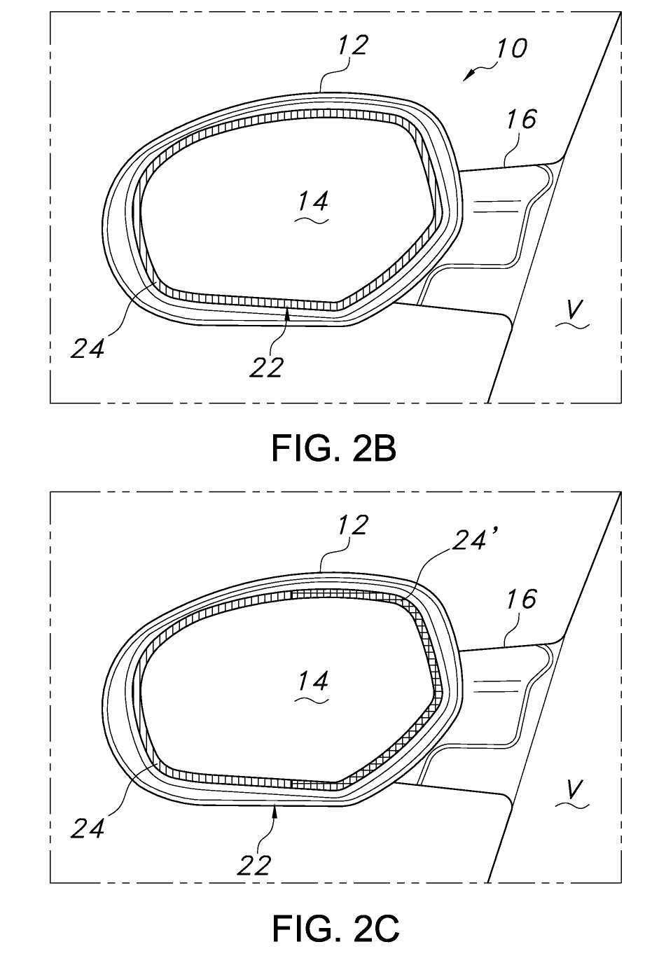

To address these issues, with reference to FIGS. 2A-2C a warning indicator system 22 is provided associated with a vehicle V rear vision mirror 10. In the embodiments depicted in FIGS. 2A-2C, like features to the features depicted in FIG. 1 are labeled with like reference numerals.

The warning indicator system 22 comprises at least one warning indicator 24 disposed on a portion of the rear vision mirror housing 12. In particular, the warning indicator 24 is disposed such that it borders or surrounds but is not positioned within the minor reflective surface 14. Thus, no portion of the reflective surface 14 is occluded. To accomplish this, typically the warning indicator 24 is disposed on an interior front portion of the housing 12 (often referred to as a “skull cap” in the industry) as shown.

In an embodiment, the warning indicator 24 is provided by means of printed LED technology defining a printed LED strip which can be provided in any desired pattern or shape. The printed LED strip comprises a random diode ink (RDI) layer or layers printed on a conductive layer, with the ink containing a plurality of suspended LEDs. Without intending any limitation, suitable printed LED technology and circuitry therefore are described in the present assignee Ford Global Technologies, LLC's U.S. patent application Ser. No. 14/684,505 for “Printed LED Animated Minor Turn Signal” and Ser. No. 14/684,496 for “Printed LED Warning Indicator Signal,” the disclosures of each of which are incorporated herein by reference in their entirety as if fully restated. At a high level, the described warning indicator 24 is operatively connected to one or both of the vehicle V turn signal control system and proximity alert warning (blind spot monitoring) system, whereby the warning indicator emits a warning signal when activated by the vehicle turn signal control system and/or the vehicle proximity sensor system detects the presence of an adjacent vehicle.

For the printed LED strip which forms the warning indicator 24 of the present disclosure, it will be appreciated that multiple colors of LED could be used to emit signals of a desired color as the technology advances. However, for reasons of cost it is known to use printed LEDs emitting a blue color, overlaid with a suitable phosphor or other dye to alter the color of the light emitted by the printed LEDs. In one embodiment, rylene phosphor and/or YAG phosphor dyes are used to change the color emitted by portions of the printed LEDs. As is known in the art, rylene and/or other phosphor dyes can be applied to shift the blue light emitted by LEDs to other desired color wavelengths, such as red and yellow/amber.

In embodiments, a thermo-formed printed LED strip may be disposed on a B surface of the housing 12, such as by adhesive, and a suitable phosphor or other dye layer may be disposed on the housing 12 A surface whereby light emitted from the B surface-mounted LED strip passes through the dye layer and is emitted as light of a desired color. Alternatively, film may be provided as the A surface, with an optional layer of decorative ink, a layer of phosphor or other suitable dye, and a thermo-formed printed LED strip disposed thereon. In yet another alternative embodiment, at least a portion of the A surface may be provided as a metalized partial vac (giving the appearance of a chrome strip) that is at least semi-permeable to light. Then, the dye layer and printed LED strip as described above could be disposed on a rear surface of the partial vac, or on the B surface to emit light through the partial vac.

Referring back to FIG. 2A, in the depicted embodiment the warning indicator 24 is operatively connected to the vehicle V turn signal control system. When the driver actuates the vehicle turn signal, warning indicator 24 emits a visible cue. As is known, typically the visible cue will be a flashing or intermittent light of a desired color, conventionally red or yellow/amber as described above.

In the embodiment of FIG. 2B, the warning indicator 24 is operatively connected to the vehicle V proximity alert warning system. When the vehicle proximity alert warning system detects an adjacent vehicle, warning indicator 24 emits a visible cue, typically a steady or intermittent light of a desired color that may be different from the color used to indicate activation of the turn signal as described above.

FIG. 2C depicts an embodiment of the described warning indicator system 22 for a vehicle V equipped with both a mirror-mounted turn signal indicator and a proximity alert warning system. In that embodiment, at least two warning indicators 24, 24′ are provided. As shown, each warning indicator 24, 24′ occupies approximately one-half of the circumference of the housing 12, i.e. borders or surrounds approximately one-half of the rear vision mirror reflective surface 14. However, it will be readily appreciated that one or the other warning indicator 24, 24′ may occupy more or less of the available circumference as desired. Still more, additional warning indicators (not shown) could be disposed on housing 12 as described, for providing additional warnings/visible cues to drivers and adjacent motorists.

In the depicted embodiment, warning indicator 24 is operatively connected to the vehicle turn signal control system and warning indicator 24′ is operatively connected to the vehicle proximity alert warning system (although of course the obverse arrangement is also contemplated). Warning indicators 24, 24′ are configured whereby warning indicator 24 emits a visible cue having a first color, and warning indicator 24′ emits a visible cue having a second color that is different from the first color. Thus, both a turn signal indicator and a proximity alert function are served via warning indicators 24, 24′ disposed on rear vision mirror 10, but without occluding any portion of reflective surface 14. Further, by warning indicators 24, 24′ emitting different visible cues the vehicle driver and adjacent motorists are apprised of whether it is the vehicle turn signal, the vehicle proximity alert warning system, or both that have been activated.

While the foregoing description provides a warning indicator 24 comprising printed LED technology, of course alternative embodiments are possible and are contemplated herein. For example, a light source such as an incandescent bulb, one or more LEDs, one or more halogen bulbs, one or more compact fluorescent bulbs, or other type of light source may be provided in an interior of the mirror housing 12, operatively connected to the vehicle V turn signal control system and/or proximity alert warning system as described above. Light emitted by such light sources disposed within housing 12 could be guided to a light emitting point substantially as shown in FIGS. 2A-2C by way of a suitable light guide, light ring, etc. Still more, blue LEDs could be used as the light source, with the blue light emitted therefrom passing through a light guide including one or more internal filters or phosphor dye elements to alter the blue light wavelength to a desired color wavelength.

Still other alternative embodiments are possible and contemplated. For example, instead of adjacent warning indicators 24, 24′ as shown in FIG. 2C, concentrically disposed warning indicators could be provided.

Still yet other alternative embodiments are possible and contemplated. Warning indicator 24 may be alternatively or additionally operatively connected to other vehicle warning systems. For example, it is known to provide a number of warning lights/icons are associated with various vehicle warning systems and which display in the vehicle instrument panel. As non-limiting examples, it is known to provide a “check engine” light, an anti-lock braking system indicator, a backup proximity alert warning indicator to alert the driver of an obstacle at the rear of the vehicle, an oil pressure warning indicator, a low tire pressure warning indicator, an overheating warning indicator, and others. The warning indicator system 22 described herein could be easily operatively connected to one or more of these systems, to provide a supplemental warning to the driver in the event that the instrument panel warning lights are unseen or ignored.

By the present disclosure, a warning indicator is provided which is associated with a vehicle rear vision mirror but which does not occlude any portion of the minor reflective surface. Conveniently, any conventional and suitable reflective surface may be used for the vehicle rear vision minor, while still providing the desirable feature of minor-mounted warning indicators. Advantageously, the indicator is significantly larger and more visible than the conventional turn signal indicator or blind spot indicator, and so is easier to see and more likely to catch the attention of a driver and/or an adjacent motorist. Moreover, printed LED technology provides hundreds of LEDs spread in an even pattern. This provides a much smoother light pattern compared to conventional LED technology which typically uses multiple LEDs to create an indicator, creating a choppy surface to the pattern.

Obvious modifications and variations are possible in light of the above teachings. All such modifications and variations are within the scope of the appended claims when interpreted in accordance with the breadth to which they are fairly, legally and equitably entitled.

1. A warning indicator system for a vehicle, comprising a warning indicator disposed on a portion of a housing of a rear vision mirror assembly of the vehicle and surrounding a reflective element supported in the rear vision mirror assembly of the vehicle, wherein the warning indicator comprises at least one printed LED strip disposed on a rearwardly facing portion of the housing surrounding the reflective element.

2. (canceled)

3. The system of claim 1, wherein the warning indicator is operatively connected to at least a turn signal control system of the vehicle.

4. The system of claim 3, wherein the warning indicator is further operatively connected to a proximity alert warning system of the vehicle.

5. The system of claim 4, wherein a first portion of the warning indicator emits a first visible cue in response to a signal received from the turn signal control system and a second portion of the warning indicator emits a second visible cue that is different from the first visible cue in response to a signal received from the proximity alert warning system.

6. (canceled)

7. A rear vision mirror assembly for a vehicle, comprising:
a housing supporting a reflective element; and
a warning indicator disposed on a portion of the housing to surround the reflective element, wherein the warning indicator comprises at least one printed LED strip disposed on a rearwardly facing portion of the housing surrounding the reflective element.

8. The assembly of claim 7, wherein the warning indicator is operatively connected to at least a turn signal control system of the vehicle.

9. The assembly of claim 8, wherein the warning indicator is further operatively connected to a proximity alert warning system of the vehicle.

10. The assembly of claim 9, wherein a portion of the warning indicator emits a first visible cue in response to a turn signal control system signal and a second portion of the warning indicator emits a second visible cue that is different from the first visible cue in response to a proximity alert warning system signal.

11. (canceled)

12. A vehicle including the assembly of claim 7.

13. A rear vision mirror assembly for a vehicle, comprising:
a housing supporting a reflective element; and
at least one printed LED strip surrounding the reflective element.

14. The assembly of claim 13, wherein the at least one printed LED strip is disposed on a rearwardly facing portion of the housing surrounding the reflective element.

15. The assembly of claim 13, wherein the warning indicator is operatively connected to at least a turn signal control system of the vehicle.

16. The assembly of claim 15, wherein the warning indicator is further operatively connected to a proximity alert warning system of the vehicle.

17. The assembly of claim 16, wherein a portion of the warning indicator emits a first visible cue in response to a turn signal control system signal and a second portion of the warning indicator emits a second visible cue that is different from the first visible cue in response to a proximity alert warning system signal.

18. A vehicle including the assembly of claim 13.
